(19) United States
(12) Patent Application Publication
(10) Pub. No.: US 2012/0124346 A1
(43) Pub. Date: May 17, 2012

(54) Decoding conditional program instructions

(75) Inventors: James Nolan Hardage, Austin, TX (US); Conrado Blasco Allue, Sunnyvale, CA (US); Glen Andrew Harris, Austin, TX (US); David James Williamson, Austin, TX (US)

(73) Assignee: ARM LIMITED, Cambridge (GB)

(21) Appl. No.: 12/926,395

(22) Filed: Nov. 15, 2010

(51) Int. Cl. G06F 9/38

(52) U.S. Cl. 712/239; 712/E09.051

(57) ABSTRACT

A processor 2 includes instruction decoding circuitry 8 and processing circuitry 16, 18, 20, 22, 24. The instruction decoding circuitry decodes at least one conditional program instruction in accordance with a conditional prediction as one of, in accordance with the condition prediction being a condition pass, one or more micro-operation instructions that control the processing circuitry to perform the processing action together with a condition resolution micro-operation instruction, or in accordance with the condition prediction being a condition fail, at least a condition resolution micro-operation instruction. Condition resolution circuitry 24 responds to the condition resolution micro-operation instruction to determine if the condition prediction is incorrect. If the condition prediction is incorrect, then the condition resolution circuitry flushes any micro-operation instructions associated with the conditional program instruction from the processing circuitry, changes the condition prediction to a new prediction and triggers the redecoding of the conditional program instruction in accordance with the new condition prediction.

### BACKGROUND OF THE INVENTION

1. Field of the Invention

This invention relates to the field of data processing systems. More particularly, this invention relates to the decoding of conditional instructions within data processing systems.

2. Description of the Prior Art

It is known to provide data processing systems which support conditional program instructions. The program instructions may be conditional by virtue of their own encoding and parameters or they may be rendered conditional by a predication instruction. It is known to speculatively process conditional program instructions before it is known whether the condition associated with that conditional instruction will be passed or failed. In order to preserve the state of the system should the conditional program instruction not pass its condition codes, it is known to provide as an additional source operand to such conditional program instructions the original value stored within the destination to be written to by that conditional program instruction. Thus, if the conditional program instruction does not pass its condition, then the original state will be available to be reinstated. A problem with this approach is that it requires extra operand routing within a processor increasing cost and circuit overhead. This is particularly the case for conditional program instructions which already have a large number of associated operands, such as, for example, single instruction multiple data (SIMD) instructions.

Another approach to dealing with conditional program instructions is to decompose them into micro-operation instructions which include within the micro-operation instructions sequence steps which store the original value of the destination into temporary storage and then restore this original destination should the conditional program instruction fail its condition. A disadvantage with this approach is that the extra micro-operation instructions slow execution of the conditional program instruction and the temporary storage is an additional resource to be provided. Furthermore, decoding a conditional program instruction in this way produces a sequence of micro-operation instructions which differ significantly from those of a non-conditional version of the same program instruction. This tends to increase the complexity and overhead associated with the instruction decoder.

### SUMMARY OF THE INVENTION

Viewed from one aspect the present invention provides an apparatus for processing data comprising:

instruction decoding circuitry configured to decode a program instruction to generate one or more micro-operation instructions;

processing circuitry configured to process said one or more micro-operation instructions, said processing circuitry including condition resolution circuitry configured to respond to a condition resolution micro-operation instruction to determine if a condition associated with said condition resolution micro-operation instruction is passed or failed; wherein

at least one conditional program instruction specifying a processing action to be performed by said processing circuitry if a condition associated with said conditional program instruction is passed is decoded by said instruction decoding circuitry in accordance with a condition prediction as one of:

(i) in accordance with said condition prediction being a condition pass prediction, one or more micro-operation instructions that control said processing circuitry to perform said processing action together with a condition resolution micro-operation instruction; and

(ii) in accordance with said condition prediction being a condition fail, at least said condition resolution micro-operation instruction; and

said condition resolution circuitry is configured to respond to said condition resolution micro-operation instruction to determine if said condition prediction is incorrect and if said condition prediction is determined to be incorrect then:

(a) to flush any micro-operation instructions for said conditional program instruction from said processing circuitry;

(b) to change said condition prediction for said conditional program instruction to a new condition prediction; and

(c) to trigger said instruction decoding circuitry to decode said conditional program instruction again using said new condition prediction.

The present technique decodes conditional program instructions into one or more micro-operation instructions in accordance with a condition prediction and includes a conditional resolution micro-operation instruction within the sequence of micro-operation instructions. Condition resolution circuitry responds to this condition resolution micro-operation to determine if the condition prediction is incorrect and should the condition prediction be incorrect serves to trigger flushing of any other micro-operations for that conditional program instruction from the processing circuitry, changing of the condition prediction for that conditional program instruction to a new condition prediction and triggering of the re-decoding of that conditional program instruction using the new condition prediction.

This approach provides a mechanism for handling condition misprediction with relatively little additional circuitry overhead although at the cost of having to replay the conditional program instructions should the condition prediction be incorrect.

It will be appreciated that the decoding of the conditional program instruction in accordance with the condition prediction being a condition fail could take a variety of different forms providing these do not inappropriately change the state of the system. However, one form of this decoding which consumes advantageously little power to execute whilst conveniently matching the number of micro-operations of the other decoding is when the conditional program instruction is decoded as a number of no-operation micro-operation instructions equal in number to the one or more micro-operation instructions that control the processing circuitry to perform the desired processing action in the condition pass decoding.

It will be appreciated that the condition resolution micro-operation instruction could be located at various positions within the sequence of micro-operation instructions into which the conditional program instructions is decoded. However, in some embodiments it is convenient that the condition resolution micro-operation instruction is the last micro-operation instruction in the sequence of micro-operations to which the conditional program instruction is decoded.

While the condition resolution micro-operation instruction could have a variety of different forms, it is convenient if it is a conditional branch micro-operation instruction. Circuitry for processing conditional branch micro-operation instructions and resolving their conditions is typically already present within a processor and accordingly support may be provided for the condition resolution micro-operation instruction with reduced overhead.

While the conditional program instruction may have a variety of different forms, one form where this technique is useful is when the conditional program instruction is a single instruction multiple data instruction as the mechanisms of forwarding the old destination value as a source operand are difficult to support with such operand dense program instructions.

As mentioned above, the conditional program instruction may itself be encoded with condition parameters, but it may also be conditional by virtue of being predicated by a predication program instruction decoded by the instruction decoding circuitry so as to predicate one or more other program instructions. In this case, the prediction instruction can render conditional a program instruction which would otherwise be non-conditional. Keeping a decoding similar to that which produces the desired processing action for the non-conditional version of the program instruction whilst supporting the conditional version of the program instruction reduces the complexity and overhead associated with the instruction decoder.

The condition resolution circuitry may conveniently be one of a plurality of processing pipelines provided within the processing apparatus concerned.

Commonality of the decoding hardware may be improved in some embodiments where the instruction decoding circuitry first decodes the conditional program instruction in accordance with the condition fail condition prediction by generating the one or more micro-operation instructions that control the processing circuitry to perform the processing action and then suppressing the sending of these one or more micro-operations to the processing circuitry.

In some embodiments the one or more micro-operation instructions corresponding to the processing action may be replaced by a corresponding number of no-operation micro-operation instructions.

Viewed from another aspect the present invention provides an apparatus for processing data comprising:

instruction decoding means for decoding a program instruction to generate one or more micro-operation instructions;

processing means for processing said one or more micro-operation instructions, said processing means including condition resolution means for responding to a condition resolution micro-operation instruction to determine if a condition associated with said condition resolution micro-operation instruction is passed or failed; wherein

at least one conditional program instruction specifying a processing action to be performed by said processing means if a condition associated with said conditional program instruction is passed is decoded by said instruction decoding means in accordance with a condition prediction as one of:

(i) in accordance with said condition prediction being a condition pass prediction, one or more micro-operation instructions that control said processing means to perform said processing action together with a condition resolution micro-operation instruction; and

(ii) in accordance with said condition prediction being a condition fail, at least said condition resolution micro-operation instruction; and

said condition resolution means responds to said condition resolution micro-operation instruction to determine if said condition prediction is incorrect and if said condition prediction is determined to be incorrect then:

(a) to flush any micro-operation instructions for said conditional program instruction from said processing means;

(b) to change said condition prediction for said conditional program instruction to a new condition prediction; and

(c) to trigger said instruction decoding means to decode said conditional program instruction again using said new condition prediction.

Viewed from a further aspect the present invention provides a method of processing data comprising the steps of:

decoding a program instruction to generate one or more micro-operation instructions;

processing said one or more micro-operation instructions, said processing including condition resolution for responding to a condition resolution micro-operation instruction to determine if a condition associated with said condition resolution micro-operation instruction is passed or failed; wherein

at least one conditional program instruction specifying a processing action to be performed if a condition associated with said conditional program instruction is passed is decoded in accordance with a condition prediction as one of:

(i) in accordance with said condition prediction being a condition pass prediction, one or more micro-operation instructions that control said processing action together with a condition resolution micro-operation instruction; and

(ii) in accordance with said condition prediction being a condition fail, at least said condition resolution micro-operation instruction; and

in response to said condition resolution micro-operation instruction, determining if said condition prediction is incorrect and if said condition prediction is determined to be incorrect then:

(a) to flush any micro-operation instructions for said conditional program instruction;

(b) to change said condition prediction for said conditional program instruction to a new condition prediction; and

(c) to trigger decoding said conditional program instruction again using said new condition prediction.

The above, and other objects, features and advantages of this invention will be apparent from the following detailed description of illustrative embodiments which is to be read in connection with the accompanying drawings.

### BRIEF DESCRIPTION OF THE DRAWINGS

FIG. 1 schematically illustrates a data processing system including mechanisms supporting conditional program instruction decoding and execution;

FIG. 2 schematically illustrates a prediction instruction serving to predicate four following otherwise non-conditional program instructions;

FIG. 3 schematically illustrates two possible decodings of a conditional program instruction into micro-operation program instructions;

FIG. 4 is a flow diagram schematically illustrating the processes of decoding and dispatch of a conditional program instruction in accordance with one example of the present techniques; and

FIG. 5 is a flow diagram schematically illustrating the processing of a condition resolution micro-operation instruction associated with one example embodiment of the present technique.

### DESCRIPTION OF THE EMBODIMENTS

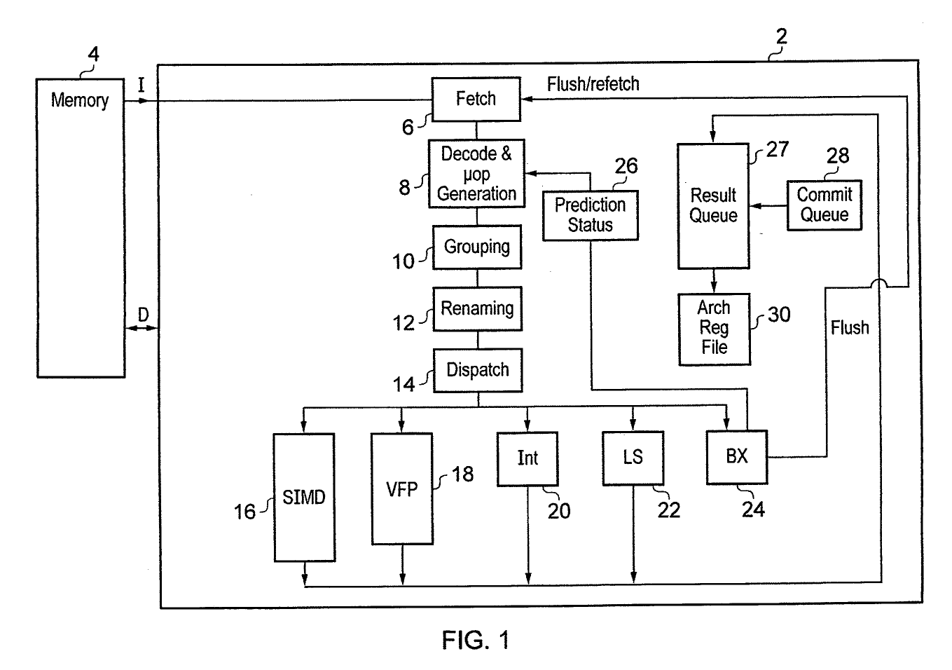

FIG. 1 schematically illustrates a processor 2 coupled to a memory 4 storing program instructions to be processed and data values to be manipulated. Within the processor 2 a stream of program instructions passes through a sequence of processing stages including a fetch stage 6, a decode and micro-op generation stage 8, a grouping stage 10, a renaming stage 12 and a dispatch stage 14 that dispatches the grouped and renamed micro-operation instructions into one of a plurality of processing pipelines including a SIMD pipeline 16, a vector floating point (VFP) pipeline 18, an integer pipeline 20, a load/store pipeline 22 and a branch resolution pipeline 24. The branch resolution pipeline 24 serves to resolve conditional branch instructions and in accordance with the present technique serves to resolve the conditional resolving micro-operation instruction which is added to each of the two decodings of the conditional program instruction in the form of a conditional branch instruction at the end of the sequence of the micro-operation instructions.

The destination operands produced by the processing pipeline 16, 18, 20 and 22 are passed to result queue circuitry where commit queue circuitry 28 serves to monitor the commit status of groups of micro-operation instructions and accordingly gate the update of an architectural register file 30 with the result values stored within the result queue circuitry 27.

The general arrangement of the processing stages and processing pipelines within the processor 2 of FIG. 1 will be familiar to those in this technical field and will not be described further herein. In particular, the processor 2 is of a type supporting out-of-order execution whereby program instructions are speculatively executed and not committed so as to update architectural state until their speculative execution has been resolved. The mechanisms provided for dealing with this type of speculative execution may be re-used to support the speculative execution of the conditional program instruction in accordance with its condition prediction and to prevent inappropriate updates of architectural state if the condition prediction is false. More particular, if the condition resolution micro-operation instruction associated with both the predicted pass and predicted fail sequences has the form of a conditional branch instruction (BX) which is resolved by the branch pipeline 24, then a condition fail for the conditional branch instruction (BX) triggers a flush of the entire micro-operation instruction sequence associated with the conditional program instruction from the relevant parts of the processing pipelines 16, 18, 20, 22 as well as triggering the prefetching and re-decoding of the conditional program instruction and a change in the condition prediction to a new condition prediction as set within a prediction status store 26 (which provides an input to the decoding and micro-op generation stage 8).

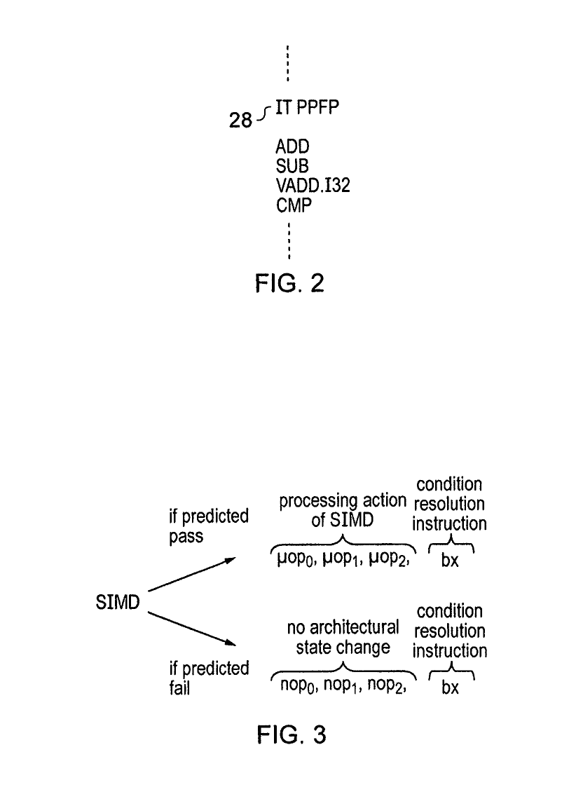

FIG. 2 schematically illustrates a prediction instruction 28 in the form of an If Then (IT) instruction followed by four flags indicating the pass or fail conditions associated with four following otherwise non-conditional program instructions. This type of IT instruction is supported within the Thumb instruction set of the processors designed by ARM Limited of Cambridge England. In the example illustrated in FIG. 2, the IT instruction 28 may be associated with a condition such as the zero flag being set and the individual four following otherwise non-conditional program instructions can be set to execute if respectively this conditional code is passed, passed, failed and passed. Thus, the SIMD instruction in the form of a vector add instruction VADD.I32 will be executed if the zero flag condition is failed and the VADD.I32 instruction rendered a conditional program instruction when it would otherwise be a non-conditional program instruction.

FIG. 3 schematically illustrates how a SIMD instruction, such as that of the example of FIG. 2, may be subject to two possible decodings into micro-operation instructions. A decoding in accordance with a predicted pass condition prediction is a sequence of micro-operation instructions to perform the processing action specified by the SIMD instruction followed by a condition resolution instruction in the form of a conditional branch instruction BX which will be failed if the condition prediction of pass for the conditional program instruction is correct. The second decoding associated with the predicted fail condition prediction for the conditional program instruction is a sequence of no-operation micro-operation instructions equal in number to the micro-operation instructions which perform the micro-operations of the SIMD instruction in the other encoding and again followed by a condition resolution instruction in the form of a conditional branch instruction. This conditional branch instruction will in the case of this decoding be failed if the prediction fail condition prediction associated with the conditional program instruction of this decoding is correct.

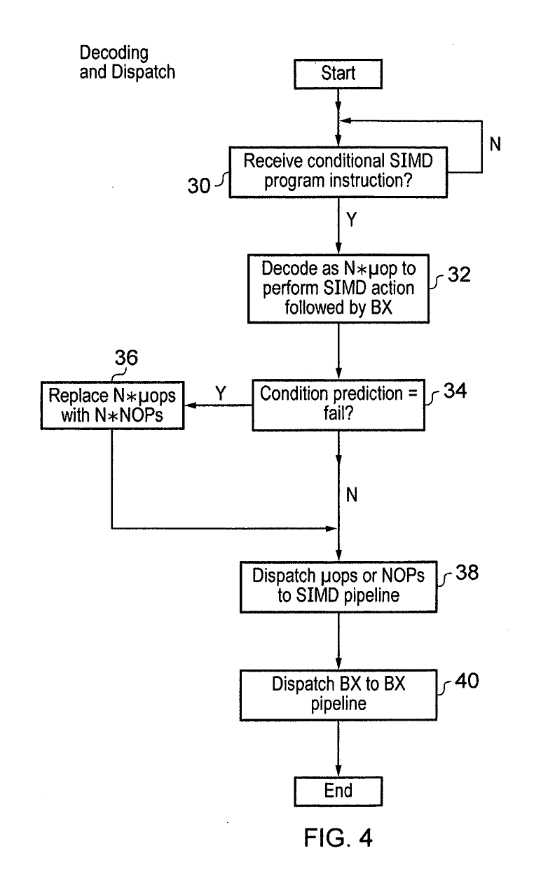

FIG. 4 schematically illustrates the decoding and dispatch of a conditional SIMD program instruction as performed by the decoding and micro-op generation stage 8 and the dispatch stage 14. At step 30 processing waits until a conditional SIMD program instruction is received. At step 32 this conditional SIMD program instruction is decoded as a sequence of micro-operation instructions to perform the SIMD processing action specified by the conditional SIMD program instruction received at step 30 and followed by a conditional branch instruction BX. This conditional branch instruction is failed if the condition associated with the conditional SIMD program instruction is passed. At step 34 the prediction status to be applied to the conditional SIMD program instruction is read from prediction status store 26. This prediction status will be initialised to a prediction of pass when the conditional SIMD program instruction is first decoded. The prediction may however be changed to a new prediction if a decoded sequence of micro-operation instructions for the conditional program instruction fails its condition resolution instruction and is flushed and re-decoded. If this is the case, then the condition prediction read from the prediction status store 26 will be fail and processing will proceed to step 36 where the micro-operations generated at, step 32 are replaced with a corresponding number of no-operation micro-operation instructions. Processing then proceeds to step 38 where the decoded sequence of micro-operation instructions (whether they be to perform the processing action of the SIMD program instruction or a sequence of no-operations) are dispatched by the dispatch unit 14. Step 40 dispatches the conditional branch instruction added to the end of the micro-operation instruction sequence to the branch resolution pipeline 24.

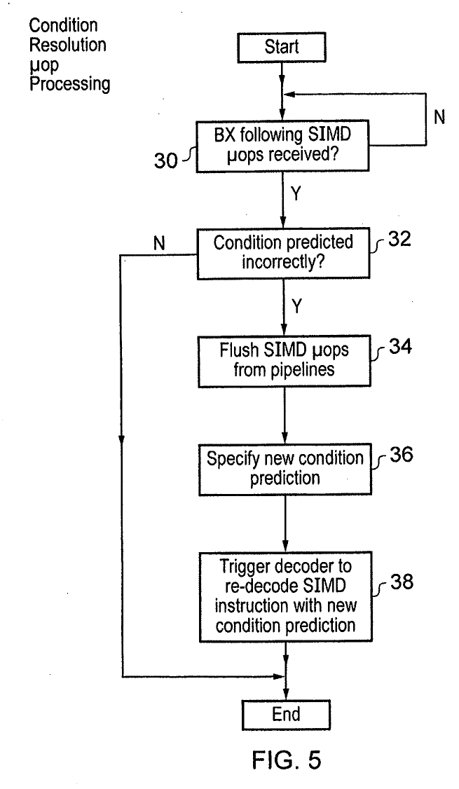

FIG. 5 is a flow diagram schematically illustrating the processing of the condition resolution micro-operation in the form of the conditional branch micro-operation by the branch resolution pipeline 24. At step 30 processing waits until a BX instruction is received. Step 32 determines whether the condition predicted for the conditional program instruction was correctly predicted by the corresponding resolution of the conditional branch BX instruction. If the condition was correctly predicted, then the conditional branch instruction can be retired and the results associated with the sequence of micro-operation instructions into which the conditional program instruction was decoded can be committed.

If the condition was incorrectly predicted, then step 34 triggers the flushing of the micro-ops associated with the conditional program instruction from the pipeline 16. Step 36 then specifies a new condition prediction and stores this within the prediction status store 26 where it will be used to control the next decoding of the replayed conditional program instruction. Step 38 then triggers the instruction decoding circuitry 8 to re-decode the conditional program instruction with the new condition prediction using a flush/refetch signal.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

We claim:

1. Apparatus for processing data comprising:
instruction decoding circuitry configured to decode a program instruction to generate one or more micro-operation instructions;
processing circuitry configured to process said one or more micro-operation instructions, said processing circuitry including condition resolution circuitry configured to respond to a condition resolution micro-operation instruction to determine if a condition associated with said condition resolution micro-operation instruction is passed or failed; wherein
at least one conditional program instruction specifying a processing action to be performed by said processing circuitry if a condition associated with said conditional program instruction is passed is decoded by said instruction decoding circuitry in accordance with a condition prediction as one of:
(i) in accordance with said condition prediction being a condition pass prediction, one or more micro-operation instructions that control said processing circuitry to perform said processing action together with a condition resolution micro-operation instruction; and
(ii) in accordance with said condition prediction being a condition fail, at least said condition resolution micro-operation instruction; and
said condition resolution circuitry is configured to respond to said condition resolution micro-operation instruction to determine if said condition prediction is incorrect and if said condition prediction is determined to be incorrect then:
(a) to flush any micro-operation instructions for said conditional program instruction from said processing circuitry;
(b) to change said condition prediction for said conditional program instruction to a new condition prediction; and
(c) to trigger said instruction decoding circuitry to decode said conditional program instruction again using said new condition prediction.

2. Apparatus as claimed in claim 1, wherein said instruction decoder is configured to decode said conditional program instruction in accordance with said condition prediction being a condition fail as a number of no-operation micro-operation instructions and said condition resolution micro-operation instruction, said number of no-operation micro-operation instructions being the same as a number of said one or more micro-operation instructions that control said processing circuitry to perform said processing action.

3. Apparatus as claimed in claim 1, wherein said condition resolution micro-operation instruction is a last micro-operation instruction in a sequence of micro-operations to which said conditional program instruction is decoded.

4. Apparatus as claimed in claim 1, wherein said conditional resolution micro-operation instruction is a conditional branch micro-operation instruction.

5. Apparatus as claimed in claim 4, wherein said condition resolution circuitry is conditional branch resolution circuitry.

6. Apparatus as claimed in claim 1, wherein conditional program instruction is single instruction multiple data program instruction and said processing action is performed upon multiple sets of operands.

7. Apparatus as claimed in claim 1, wherein said instruction decoding circuitry is configured to respond to a predication program instruction to predicate one or more other program instructions.

8. Apparatus as claimed in claim 7, wherein said conditional program instruction is a non-conditional program instruction predicated by said predication program instruction.

9. Apparatus as claimed in claim 8, wherein said conditional resolution circuitry returns at least some characteristics of said predication program instruction to said instruction decoding circuitry when triggering said instruction decoding circuitry to decode said conditional program instruction again using said new condition prediction.

10. Apparatus as claimed in claim 1, wherein said processing circuitry comprises a plurality of processing pipelines and said condition resolution circuitry is one of said plurality of processing pipelines.

11. Apparatus as claimed in claim 1, wherein said instruction decoding circuitry is configured to decode said conditional program instruction in accordance with said condition prediction being a condition fail, by generating said one or more micro-operation instructions that control said processing circuitry to perform said processing action and then suppressing sending of said one or more micro-operations instructions to said processing circuitry.

12. Apparatus as claimed in claim 11, wherein said one or more micro-operation instructions are replaced by a corresponding number of no-operation micro-operation instructions.

13. Apparatus for processing data comprising:
instruction decoding means for decoding a program instruction to generate one or more micro-operation instructions;
processing means for processing said one or more micro-operation instructions, said processing means including condition resolution means for responding to a condition resolution micro-operation instruction to determine if a condition associated with said condition resolution micro-operation instruction is passed or failed; wherein
at least one conditional program instruction specifying a processing action to be performed by said processing means if a condition associated with said conditional program instruction is passed is decoded by said instruction decoding means in accordance with a condition prediction as one of:
(i) in accordance with said condition prediction being a condition pass prediction, one or more micro-operation instructions that control said processing means to perform said processing action together with a condition resolution micro-operation instruction; and
(ii) in accordance with said condition prediction being a condition fail, at least said condition resolution micro-operation instruction; and
said condition resolution means responds to said condition resolution micro-operation instruction to determine if said condition prediction is incorrect and if said condition prediction is determined to be incorrect then:
(a) to flush any micro-operation instructions for said conditional program instruction from said processing means;
(b) to change said condition prediction for said conditional program instruction to a new condition prediction; and
(c) to trigger said instruction decoding means to decode said conditional program instruction again using said new condition prediction.

14. A method of processing data comprising the steps of:
decoding a program instruction to generate one or more micro-operation instructions;
processing said one or more micro-operation instructions, said processing including condition resolution for responding to a condition resolution micro-operation instruction to determine if a condition associated with said condition resolution micro-operation instruction is passed or failed; wherein
at least one conditional program instruction specifying a processing action to be performed if a condition associated with said conditional program instruction is passed is decoded in accordance with a condition prediction as one of:
(i) in accordance with said condition prediction being a condition pass prediction, one or more micro-operation instructions that control said processing action together with a condition resolution micro-operation instruction; and
(ii) in accordance with said condition prediction being a condition fail, at least said condition resolution micro-operation instruction; and
in response to said condition resolution micro-operation instruction, determining if said condition prediction is incorrect and if said condition prediction is determined to be incorrect then:
(a) to flush any micro-operation instructions for said conditional program instruction;
(b) to change said condition prediction for said conditional program instruction to a new condition prediction; and
(c) to trigger decoding said conditional program instruction again using said new condition prediction.

15. A method as claimed in claim 14, wherein said step of decoding decodes said conditional program instruction in accordance with said condition prediction being a condition fail as a number of no-operation micro-operation instructions and said condition resolution micro-operation instruction, said number of no-operation micro-operation instructions being the same as a number of said one or more micro-operation instructions that control said processing action.

16. A method as claimed in claim 14, wherein said condition resolution micro-operation instruction is a last micro-operation instruction in a sequence of micro-operations to which said conditional program instruction is decoded.

17. A method as claimed in claim 14, wherein said conditional resolution micro-operation instruction is a conditional branch micro-operation instruction.

18. A method as claimed in claim 14, wherein conditional program instruction is single instruction multiple data program instruction and said processing action is performed upon multiple sets of operands.

19. A method as claimed in claim 14, wherein said step of decoding responds to a predication program instruction to predicate one or more other program instructions.

20. A method as claimed in claim 19, wherein said conditional program instruction is a non-conditional program instruction predicated by said predication program instruction.

21. A method as claimed in claim 20, comprising returning at least some characteristics of said predication program instruction as inputs to decode said conditional program instruction again using said new condition prediction.

22. A method as claimed in claim 14, wherein said step of decoding decodes said conditional program instruction in accordance with said condition prediction being a condition fail, by generating said one or more micro-operation instructions that control said processing action and then suppressing further use of said one or more micro-operations instructions.

23. A method as claimed in claim 22, wherein said one or more micro-operation instructions are replaced by a corresponding number of no-operation micro-operation instructions.
